(19) United States
(12) Patent Application Publication
(10) Pub. No.: US 2026/0065327 A1
(43) Pub. Date: Mar. 5, 2026

(54) USING A LARGE LANGUAGE MODEL TO GENERATE CONTENT BASED ON IMAGES CAPTURED AT A SOURCE LOCATION

(71) Applicant: Maplebear Inc., San Francisco, CA (US)

(72) Inventors: Brent Scheibelhut, Toronto (CA); Shaun Navin Maharaj, Vaughan (CA); Akshay Bagai, Toronto (CA); Michael John Remmer Ryzewic, Ithaca, NY (US); Naval Shah, Toronto (CA)

(21) Appl. No.: 18/821,738

(22) Filed: Aug. 30, 2024

(51) Int. Cl. G06Q 30/0241; G06Q 10/087; G06Q 30/0202; G06Q 30/0204; G06V 20/62

(52) U.S. Cl. CPC G06Q 30/0276; G06Q 10/087; G06Q 30/0202; G06Q 30/0205; G06V 20/62

(57) ABSTRACT

An online system receives an image captured at a source location, in which the image depicts one or more objects. The system generates a prompt including the image and a request to identify, from the objects, a set of items available at the source location based on a database of items available at the source location, and to extract, from the image, text describing a price or a promotion associated with each identified item. The system provides the prompt to a large language model to obtain an output, in which the model is fine-tuned based on the database of items. The system extracts, from the output, an identifier and the text associated with each item, retrieves item data for each item based on the identifier associated with the item, and generates promotional content for the source location based on the item data and the price or promotion associated with each item.

### BACKGROUND

Online systems may provide their users with the convenience of allowing them to place orders that are serviced by pickers on behalf of the users. The pickers may service the orders by driving to source locations, collecting items included in the orders, and delivering the orders to the users who placed the orders. Ordering interfaces through which the users may order items may include promotional content (e.g., weekly flyers) describing sales, discounts, coupons, or other promotions associated with various items available at source locations.

Conventionally, the process of creating promotional content for a source location involves multiple steps that are performed manually or by third-party integrations. These steps may include evaluating the inventory of items available at the source location, comparing the prices of the items with the prices of items elsewhere, selecting the items to be promoted, capturing images of the selected items, selecting a template for the promotional content, determining the placement of the selected items in the template (e.g., based on the layout of the template and associations between the items), etc. Although large sources (e.g., corporations) that operate multiple source locations (e.g., chains or franchises) may have budgets, employees, or other resources dedicated to creating promotional content, the process of creating promotional content does not scale well for small or midsize sources that may not have such resources.

### SUMMARY

In accordance with one or more aspects of the disclosure, an online system generates promotional content based on content extracted by a large language model from an image captured at a source location. More specifically, an online system receives one or more images captured at a source location, in which the images depict one or more objects. The online system generates a prompt including the images, a request to identify, from the objects, a set of items available at the source location based on a database of items available at the source location, and a request to extract, for each identified item, text associated with a corresponding item from the images, in which the text describes a price or a promotion. The online system provides the prompt to a multi-modal large language model to obtain an output, in which the model is fine-tuned based on the database of items. The online system extracts, from the output, an identifier and the text associated with each item, retrieves a set of item data for each item based on the identifier associated with a corresponding item, and generates promotional content for the source location based on the set of item data and the price or the promotion associated with each item.

Thus, promotional content for a source location may be created automatically without human intervention and without the use of third-party integrations. As such, the promotional content may be created in a manner that is more efficient than the process that is conventionally used, especially when the source location is operated by a small or midsize source that may not have resources dedicated to creating the promotional content.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for generating promotional content based on content extracted by a large language model from an image captured at a source location, in accordance with one or more embodiments.

FIG. 4A illustrates an example of an image captured at a source location, in accordance with one or more embodiments.

FIGS. 4B-4C illustrate examples of promotional content generated based on a template and content extracted by a large language model from an image captured at a source location, in accordance with one or more embodiments.

### DETAILED DESCRIPTION

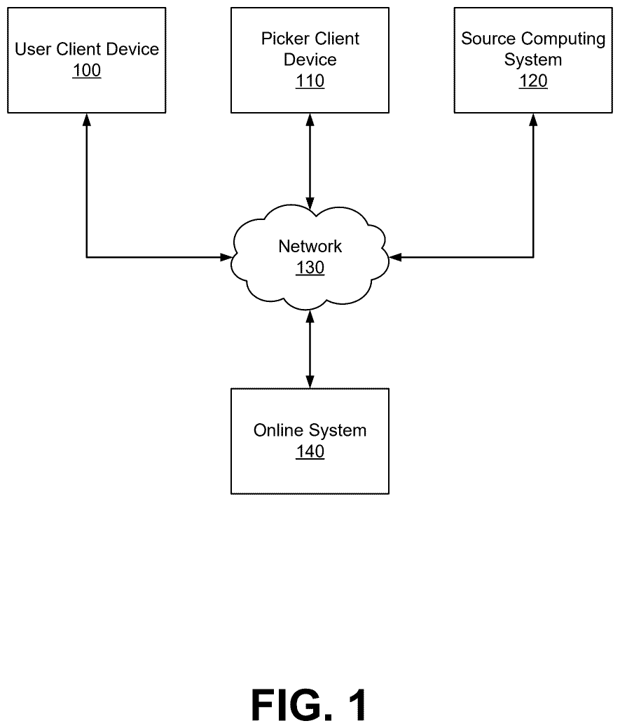

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more source locations from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi-or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart.

In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

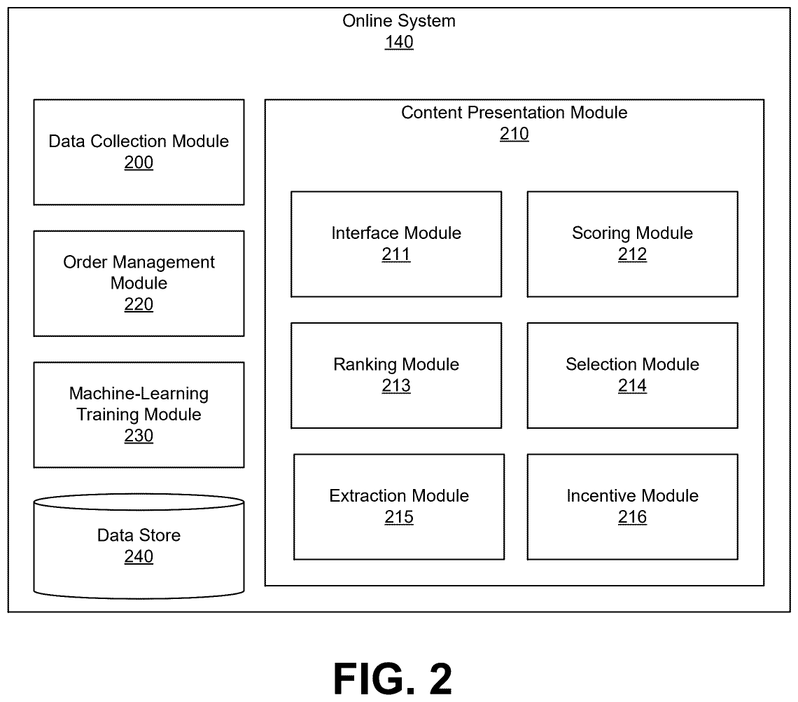

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, preferences (e.g., shopping or dietary preferences, favorite items, sources, source locations, or cuisines, etc.), or stored payment instruments. User data also may include demographic information associated with a user (e.g., age, gender, geographical region, etc.) or household information associated with the user (e.g., a number of people in the user's household, whether the user's household includes children or pets, etc.). The user data also may include default settings established by a user, such as a default source or source location, payment instrument, delivery location, or delivery timeframe. The user data further may include one or more user engagement scores associated with a user, as further described below.

User data further may include historical information associated with a user, such as historical conversion or interaction information. For example, user data may include historical conversion information, such as historical order information associated with a user describing previous orders the user placed with one or more sources or historical purchase information associated with the user describing previous purchases the user made for themselves from one or more source locations. In this example, the historical order information may describe one or more items included in each order (e.g., an item category, a size, a brand, a quantity, a price, etc. associated with each item), a time each order was placed, a source location from which the items included in each order were collected, etc. Similarly, in this example, the historical purchase information may describe one or more items included in each purchase, a time each purchase was made, a source location from which each purchase was made, etc. As an additional example, user data may include historical interaction information describing each item presented by the online system 140 with which a user interacted and a type of each interaction (e.g., searching for an item, adding an item to an ordering list, etc.), as well as information describing each item presented by the online system 140 with which the user did not interact. In the above example, the historical interaction information also may describe a time associated with each interaction (e.g., a time at which a search query for an item was received, a time an item was added to an ordering list, etc.) and a time at which each item with which the user did not interact was presented to the user. The data collection module 200 may collect the user data from sensors on the user client device 100 or based on the user's interactions with the online system 140. The data collection module 200 also may collect the user data from other components of the online system 140, a source computing system 120, a third-party system (e.g., a website or an application), or any other suitable source.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), serial number, price, promotion, item category, brand, quality (e.g., freshness, ripeness, etc.), ingredients or materials, manufacturing location, version or variety (e.g., flavor, low fat, gluten-free, organic, etc.), availability or seasonality, or any other suitable attributes of an item. The item data also may include images or videos of items, descriptions of items, or any other suitable types of information. The item data may be organized into a catalog of items that the data collection module 200 receives from a source. Alternatively, the data collection module 200 may generate the catalog of items from the item data and update it (e.g., as new item data is received). The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100. The data collection module 200 also may collect item data from other components of the online system 140.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the source locations from which the picker has collected items, or the picker's previous shopping history. Additionally, the picker data may include preferences expressed by the picker, such as their preferred source locations for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data include user data for users associated with the order, such as user data for a user who placed the order or picker data for a picker who serviced the order.

Similarly, the data collection module 200 may collect purchase data, which is information or data describing characteristics of a purchase by a user who collected and purchased items for themselves from a source location. The purchase data may include item data for items included in purchases, user data for users associated with purchases, or any other suitable types of information. For example, purchase data for a purchase may include item data for items that are included in the purchase, user data for a user who made the purchase, and information describing the purchase (e.g., a source location from which the user purchased the items and a date and time of the purchase).

Furthermore, the data collection module 200 may collect source data, which is information or data identifying and describing characteristics of a source. Source data may include information identifying a source (e.g., a name of the source) and information describing one or more source locations operated by the source, such as a geographical location (e.g., an address) of each source location, hours of operation of each source location, etc. Source data also may include information describing promotions for items available at each source location. For example, source data may describe a day of the week that new promotions are available at a source location. Additionally, source data may include a set of preferences associated with a source. A set of preferences associated with a source may indicate whether the source prefers promotional content for a source location operated by the source to be generated using a particular template or for the promotional content to be in a particular format. Examples of formats for promotional content for a source location include a newsletter, an interactive collection of items, or any other suitable types of formats. Additionally, source data may include promotional content generated for a source location. Promotional content generated for a source location may be stored in association with information identifying the source location or a user for which the promotional content was generated, one or more times associated with the promotional content (e.g., a time at which it was generated, a timeframe during which prices or promotions included in the promotional content are valid, etc.), or any other suitable types of information.

Source data also may include one or more images or videos captured at a source location. The images or videos may depict one or more objects corresponding to items, organizational elements (e.g., aisles, shelves, display cases, etc.), labels, banners, or any other suitable types of objects. In embodiments in which the source data include an image or a video captured at a source location, the image or video may be stored in the data store 240 in association with information identifying the source location, a time at which the image or video was captured, or any other suitable types of information. The data collection module 200 may collect source data from a picker client device 110, a user client device 100, a source computing system 120, other components of the online system 140, or any other suitable source of source data. For example, one or more images or videos collected by the data collection module 200 may be captured at a source location by a picker client device 110 associated with a picker collecting items from the source location, a camera of a client device operated by a source that operates the source location, etc.

The data collection module 200 also collects template data, which include templates for promotional content that may be generated for source locations, as well as information or data describing characteristics of the templates. As described above, formats for promotional content for a source location may include a newsletter, an interactive collection of items, etc. A template for promotional content may include a title, a background, slots that may be populated with various types of information, interactive elements, or any other suitable types of components. The data collection module 200 may collect the template data from a source computing system 120, a third-party system (e.g., a website or an application), or any other suitable source.

While user data, picker data, item data, order data, purchase data, source data, and template data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. Components of the content presentation module 210 include: an interface module 211, a scoring module 212, a ranking module 213, a selection module 214, an extraction module 215, and an incentive module 216, which are further described below.

The interface module 211 generates and transmits an ordering interface for a user to order items. The interface module 211 populates the ordering interface with items that the user may select for adding to their order. In some embodiments, the interface module 211 presents a catalog of all items that are available to the user, which the user can browse to select items to order. Other components of the content presentation module 210 may identify items that the user is most likely to order and the interface module 211 may then present those items to the user. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items.

The interface module 211 also may retrieve, from the data store 240, a set of item data for each item included among a set of items available at a source location. The set of items may be identified based on an identifier for each item extracted by the extraction module 215, as described below. For example, based on a serial number associated with an item available at a source location, the interface module 211 may retrieve a set of item data for the item, in which the set of item data includes an image and a description of the item. In some embodiments, the interface module 211 only retrieves a set of item data for each item available at a source location that is associated with a promotion.

The interface module 211 also may generate promotional content for a source location. The interface module 211 may do so based on a price or a promotion associated with each item included among a set of items available at the source location, other types of item data for each item, source data associated with the source location, or any other suitable types of information. Promotional content for a source location may be static or interactive. For example, promotional content for a source location may be a static flyer in a Portable Document Format (PDF). Alternatively, in the above example, the promotional content may be an interactive flyer including images of items, in which each image of an item corresponds to an interactive element, such that a pop-up window with information describing an item and an option to add the item to an ordering list appear upon receiving an interaction with an image of the item.

The interface module 211 may generate promotional content for a source location based on a template for the promotional content. The interface module 211 may select the template from the template data in the data store 240 based on a set of preferences associated with a source that operates the source location. For example, if a set of preferences associated with a source that operates a source location describes a particular template the source prefers for generating promotional content for the source location, the interface module 211 may select the template from the data store 240. Alternatively, in this example, if the set of preferences indicates the source prefers the template to be in a particular format (e.g., a newsletter or an interactive collection of items), the interface module 211 may select the template from one or more templates in the format stored in the data store 240. The interface module 211 also may select the template based on a number of items available at the source location that may be included in the promotional content, types of promotions associated with the items, one or more attributes of the items, or any other suitable types of information. For example, the interface module 211 may select a template for a weekly flyer for a source location based on a number of slots within the template that may be populated with items and a number of items to be included in the flyer, such that the number of slots may accommodate the number of items. In this example, the interface module 211 also may select the template based on a relatedness of the items to be included in the flyer with each other or types of promotions associated with the items, such that items that are more closely related to each other or items that are associated with similar types of promotions may be located in the same area (e.g., the same page) of the flyer. In the above example, the interface module 211 may determine a relatedness of the items to each other based on one or more item categories associated with each item or by applying one or more natural language processing (NLP) techniques to text associated with the items.

Once the interface module 211 selects a template for generating promotional content for a source location, the interface module 211 may generate the promotional content by populating the template with an image and a description of each of a set of items available at the source location and overlaying a price or a promotion associated with each item (e.g., onto a portion of the image of the item). For example, the interface module 211 may populate each slot of a template with an image and a brand, an item category, and a stock keeping unit (SKU) associated with each of a set of items available at a source location. In this example, the interface module 211 also may overlay a price or a promotion associated with each item onto an image of a corresponding item. As described below, in some embodiments, the ranking module 213 ranks the set of items available at the source location (e.g., based on a price, a promotion, a score, etc. associated with each item). In such embodiments, the interface module 211 may populate the template with an image and a description of each of the set of items based on the ranking (e.g., such that a highest ranked item occupies a most prominent slot of the template, a second-highest ranked item occupies a second-most prominent slot of the template, etc.). Furthermore, in embodiments in which the ranking is based on information that is specific to a user (e.g., a user engagement score, as described below), the promotional content may be generated for the user.

Once the interface module 211 generates promotional content for a source location, it subsequently may execute various steps associated with the promotional content. In some embodiments, the interface module 211 communicates information describing the promotional content to the data collection module 200, which stores the promotional content in the data store 240. The interface module 211 also may receive a request from a user client device 100 associated with a user of the online system 140 to access the promotional content for the source location and send the promotional content to the user client device 100, causing the user client device 100 to display the promotional content. For example, responsive to receiving a request from a user client device 100 associated with a user to access promotional content for a source location, the interface module 211 may retrieve promotional content for the source location generated for the user and send the promotional content to the user client device 100. Furthermore, in some embodiments, once the interface module 211 generates the promotional content, it communicates information describing the promotional content to a source that operates the source location for approval (e.g., via a source computing system 120 associated with the source). In such embodiments, once the interface module 211 receives approval for the promotional content, it communicates information describing the promotional content to the data collection module 200 for storage in the data store 240 or sends the promotional content to a user client device 100 in response to receiving a request to access the promotional content from the user client device 100.

In some embodiments, once the data collection module 200 updates item data (e.g., in a catalog of items) with a price or a promotion associated with an item, the interface module 211 receives a request from a user client device 100 to access a user interface, such as the ordering interface or another type of user interface, in which the user interface includes information describing the item. In such embodiments, the interface module 211 then retrieves, from the updated item data, the price, the promotion, or other types of information associated with the item, and generates the user interface based on the retrieved information. The interface module 211 may then send the user interface to the user client device 100, causing the user client device 100 to display the user interface. For example, suppose that a catalog of items available at a source location has been updated with a price or a promotion associated with an item and that the interface module 211 receives a search query from a user client device 100 associated with a user, in which the search query identifies the item and the source location. In this example, suppose also that other components of the content presentation module 210 (e.g., the scoring module 212, the ranking module 213, and the selection module 214) have scored the item based on the search query and have ranked and selected the item for presentation to the user. Continuing with this example, the interface module 211 may then retrieve, from the updated catalog of items, an image of the item, information describing or identifying the item (e.g., a brand, an item category, and a size associated with the item), and the price or the promotion associated with the item. In the above example, the interface module 211 may generate the user interface based on the retrieved information, such that the user interface includes the image of the item, the information describing or identifying the item, as well as the price or the promotion associated with the item, and send the user interface to the user client device 100, which then displays the user interface.

In embodiments in which the incentive module 216 determines that an incentive for capturing one or more images or videos depicting one or more items at a source location should be offered and a type or an amount of the incentive, as described below, the interface module 211 sends information describing the incentive to one or more picker client devices 110. For example, if a picker is collecting items for an order from a source location, the interface module 211 may send information to a picker client device 110 associated with the picker describing a monetary amount of an incentive for capturing one or more images or videos depicting an item at the source location. Alternatively, in the above example, the interface module 211 may send the information to the picker client device 110 if a location associated with the picker (e.g., a location of the picker client device 110) is within a threshold distance of the source location. Information describing an incentive for capturing one or more images or videos depicting one or more items at a source location may be sent to a picker client device 110 via a push notification, an email, or via any other suitable means. Once sent to the picker client device 110, the picker client device 110 may display the information describing the incentive.

The scoring module 212 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the scoring module 212 scores items based on a search query received from the user client device 100. A search query is free text for a word or set of words that indicate items of interest to the user. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a user (e.g., by comparing a search query embedding to an item embedding).

In some embodiments, the scoring module 212 scores items based on a predicted availability of an item. The scoring module 212 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The scoring module 212 may apply a weight to the score for an item based on the predicted availability of the item. Alternatively, an item may be filtered out from presentation to a user by the selection module 214 based on whether the predicted availability of the item exceeds a threshold.

The scoring module 212 also may retrieve various types of data from the data store 240. Examples of types of data the scoring module 212 may retrieve from the data store 240 include a set of user data for a user, a set of item data for an item, or any other suitable types of data. For example, the scoring module 212 may retrieve information describing a set of user data for a user, such as a set of preferences associated with the user or demographic or household information associated with the user. In the above example, the set of user data also may include historical conversion information associated with the user, such as historical order or purchase information associated with the user, or historical interaction information associated with the user. Continuing with this example, the scoring module 212 also may retrieve a catalog of items available at a source location, such as an image and a description of each item, a price or a promotion associated with each item, etc.

The scoring module 212 also may predict a user engagement score for an item. A user engagement score is specific to a user and indicates a likelihood of an interaction by the user with an item available at a source location. A user may interact with an item available at a source location by adding the item to an ordering list, placing an order including the item, etc. A user engagement score may correspond to a value, such as a number or a percentage. For example, a user engagement score for an item may correspond to a value from zero to one, in which a value of zero indicates a user is highly unlikely to interact with the item and a value of one indicates the user is highly likely to interact with the item. The scoring module 212 may predict a user engagement score for an item based on a set of user data for a user, a set of item data for the item, or any other suitable types of information. Once the scoring module 212 predicts a user engagement score for an item, the scoring module 212 may communicate information describing the user engagement score to the data collection module 200, which may store it in the data store 240.

In some embodiments, the scoring module 212 predicts a user engagement score for an item using an engagement prediction model, which is a machine-learning model trained to predict a user engagement score for an item. To use the engagement prediction model, the scoring module 212 may access the model (e.g., from the data store 240) and apply the model to a set of inputs. The set of inputs may include one or more types of data (e.g., user data, item data, etc.) retrieved by the scoring module 212 described above or any other suitable types of information. For example, the scoring module 212 may access and apply the engagement prediction model to a set of inputs including a set of user data for a user describing historical conversion or interaction information associated with the user, a set of preferences associated with the user, demographic or household information associated with the user, etc. In the above example, the set of inputs also may include a set of item data for an item, such as a set of attributes (e.g., a brand, an item category, a price, a promotion, etc.) of the item. Once the scoring module 212 applies the engagement prediction model to the set of inputs, the scoring module 212 may receive an output from the model, which may include a value corresponding to a user engagement score for an item. In some embodiments, the engagement prediction model is trained by the machine-learning training module 230, as described below.

The ranking module 213 may rank items based on various types of information associated with the items. In some embodiments, the ranking module 213 ranks items based on a set of item data for each item, such as a price or a promotion associated with each item. For example, the ranking module 213 may rank items based on their prices, such that a rank of an item is inversely proportional to its price. In the above example, the ranking module 213 also or alternatively may rank the items based on any discounts associated with the items, such that a rank of an item is proportional to an amount or a percentage of a discount associated with the item. In embodiments in which the scoring module 212 predicts user engagement scores for items, the ranking module 213 also may rank the items based on user engagement scores associated with a user. In the above example, the ranking module 213 also may rank the items based on a user engagement score for each item, such that a rank of an item is proportional to the user engagement score for the item.

The extraction module 215 may retrieve one or more images or videos captured at a source location from the data store 240. As described above, the images or videos may depict one or more objects corresponding to items, organizational elements (e.g., aisles, shelves, display cases, etc.), labels, banners, etc. For example, the extraction module 215 may retrieve an image or a video captured at a source location depicting shelves at the source location, in which multiple types of items are arranged on each shelf. In this example, the image or video also may depict one or more labels including a name of each item, a price of each item, and a promotion associated with each item, if any. As also described above, the images or videos may be stored in the data store 240 in association with information identifying the source location, a time at which the images or videos were captured, etc. The images or videos retrieved by the extraction module 215 may have been captured within a threshold amount of time of a current time. In the above example, based on source data describing a day of the week that new promotions are available at the source location, the image or video retrieved by the extraction module 215 may have been captured at the source location since a time that the newest promotions became available at the source location.

The extraction module 215 also may generate a prompt. The prompt may include one or more images or videos captured at a source location. The prompt also may include a request to identify a set of items available at the source location from one or more objects depicted in the images or videos based on item data for items available at the source location. For example, the prompt may include a request to identify a set of items from one or more objects depicted in an image captured at a source location based on one or more images or attributes (e.g., item categories, brands, stock keeping units (SKUs), versions or varieties, etc.) of items included among a catalog of items available at the source location. Additionally, the prompt may include a request to extract, for each identified item, text associated with a corresponding item from the images or videos, in which the text describes a price or a promotion. Promotions associated with items may include a sale (e.g., a flash sale), a coupon (e.g., $1.00 off), a discount (e.g., 30% off), an offer (e.g., buy one, get one half off), a free sample or trial, a rebate, a bundle (e.g., mix and match three items of the same brand to get $2.00 off), or any other suitable types of promotions. The prompt also may include item data for items available at the source location (e.g., as a catalog of items). Additionally, the prompt may include information that may be used to infer that an identified item is associated with a promotion, or any other suitable types of information. For example, the prompt may include information indicating that an item is associated with a promotion if an image or a video depicting the item at a source location includes a sale banner, if a price of the item is crossed out and replaced with a lower price, if a price of the item is lower than a price of the item included in a catalog of items available at the source location, if the item is depicted in an end cap or at eye level, etc.

The extraction module 215 may provide a prompt it generates to a multi-modal large language model (LLM) or any other suitable type of generative artificial intelligence (AI) model to obtain an output. The multi-modal LLM (or other generative AI model) may be fine-tuned based on item data for items available at a source location. For example, the multi-modal LLM may be fine-tuned based on a catalog of items available at a source location (e.g., one or more images or videos of each item and one or more attributes, such as a brand, an item category, a version or variety, etc., of each item). The multi-modal LLM (or other generative AI model) also may access the item data for the items via an application programming interface (API). The multi-modal LLM (or other generative AI model) may apply one or more computer vision algorithms, such as you only look once (YOLO), optical character recognition (OCR), etc., to one or more images or videos captured at the source location included in the prompt. The computer vision algorithms may identify, from one or more objects depicted in the images or videos, a set of items available at the source location. The computer vision algorithms also may extract, for each identified item, text describing a price or a promotion associated with a corresponding item from the images or videos. In some embodiments, text extracted by the computer vision algorithms also includes information describing or identifying an item, such as a stock keeping unit (SKU), a brand, an item category, etc. associated with the item. The multi-modal LLM (or other generative AI model) also may apply one or more natural language processing (NLP) techniques to any text it extracts.

Once the extraction module 215 obtains an output from a multi-modal LLM (or other generative AI model), the extraction module 215 may extract, from the output, an identifier and text associated with each item included among a set of items available at a source location. An identifier associated with an item may correspond to a stock keeping unit (SKU), a price look-up (PLU) code, a serial number, one or more attributes (e.g., an item category or a combination of a brand, an item category, and a version or variety associated with the item), or any other suitable type of identifier. As described above, text associated with each item may include a price or a promotion associated with a corresponding item. For example, the extraction module 215 may extract, from an output of the multi-modal LLM, an item category (e.g., “Granny Smith apple”) and a promotion (e.g., “2 for $1.50”) associated with a first item available at a source location and an item category (e.g., “Bartlett pear”) and a price (e.g., “$1.35 Each”) associated with a second item available at the source location. In this example, the extraction module 215 also may extract, from the output, an item category (e.g., “green seedless grapes”) and a price (e.g., “$4.23 Each”) associated with a third item available at the source location, an item category (e.g., “navel orange”), a price (e.g., “$1.12”), and a promotion (e.g., $0.38 off an original price of $1.50) associated with a fourth item available at the source location, etc. In some embodiments, once the extraction module 215 extracts a price or a promotion associated with an item, the extraction module 215 communicates information describing the price or the promotion to the data collection module 200, which stores or updates item data for the item in the data store 240.

The incentive module 216 may determine whether to offer an incentive for capturing one or more images or videos depicting one or more items at a source location and a type or an amount of the incentive that should be offered. An incentive may be monetary (e.g., a bonus) or non-monetary (e.g., priority access to offers to service orders). The incentive module 216 may make the determination based on an amount of time that has elapsed since a time that a price of an item at a source location was last received by the data collection module 200, a number of items at the source location for which the data collection module 200 has not received prices for at least a threshold amount of time, or any other suitable types of information. For example, the incentive module 216 may determine that an incentive corresponding to priority access to offers to service orders should be offered for capturing an image or a video of an item at a source location if it has been at least four days since a time that a price of the item at the source location was last received by the data collection module 200. In this example, the incentive module 216 may determine that a monetary incentive also or alternatively should be offered for capturing the image or video if it has been at least a week since the price of the item at the source location was received by the data collection module 200 or if there are additional items at the source location for which the data collection module 200 has not received prices for at least a week. In the above example, an amount of the monetary incentive may be proportional to the amount of time (e.g., hours or days) that has elapsed or the number of additional items. Once the incentive module 216 determines that an incentive should be offered for capturing one or more images or videos depicting one or more items at a source location and a type or an amount of the incentive, the incentive module 216 may communicate information describing the incentive to the interface module 211, which may then send the information to one or more picker client devices 110, as described above.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large language models, or multi-modal large language models. A machine-learning model may include components relating to these different general categories of model, which may be sequenced, layered, or otherwise combined in various configurations.

While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, purchase data, source data, or template data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the scoring module 212 accesses and applies the engagement prediction model to predict a user engagement score for an item, the machine-learning training module 230 may train the engagement prediction model. The machine-learning training module 230 may train the engagement prediction model via supervised learning or using any other suitable technique or combination of techniques based on data stored in the data store 240 or any other suitable types of data. For example, the machine-learning training module 230 may train the engagement prediction model based on user data, item data, or any other types of data stored in the data store 240.

To illustrate an example of how the machine-learning training module 230 may train the engagement prediction model, suppose that the machine-learning training module 230 receives a set of training examples including various attributes of items (e.g., item categories, brands, prices, promotions, etc.) available at one or more source locations. In this example, the set of training examples also may include various attributes of users of the online system 140, which may describe historical conversion or interaction information associated with each user, each user's preferences, demographic or household information associated with each user, etc. In the above example, the machine-learning training module 230 also may receive labels which represent expected outputs of the engagement prediction model, in which a label describes, for each item, user engagement by one or more users with a corresponding item available at a source location (e.g., adding the item to an ordering list associated with the source location, placing an order including the item, etc.). Continuing with this example, the machine-learning training module 230 may then train the engagement prediction model based on the attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross-entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, purchase data, source data, template data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

### GENERATING PROMOTIONAL CONTENT BASED ON CONTENT EXTRACTED BY A LARGE LANGUAGE MODEL FROM AN IMAGE CAPTURED AT A SOURCE LOCATION

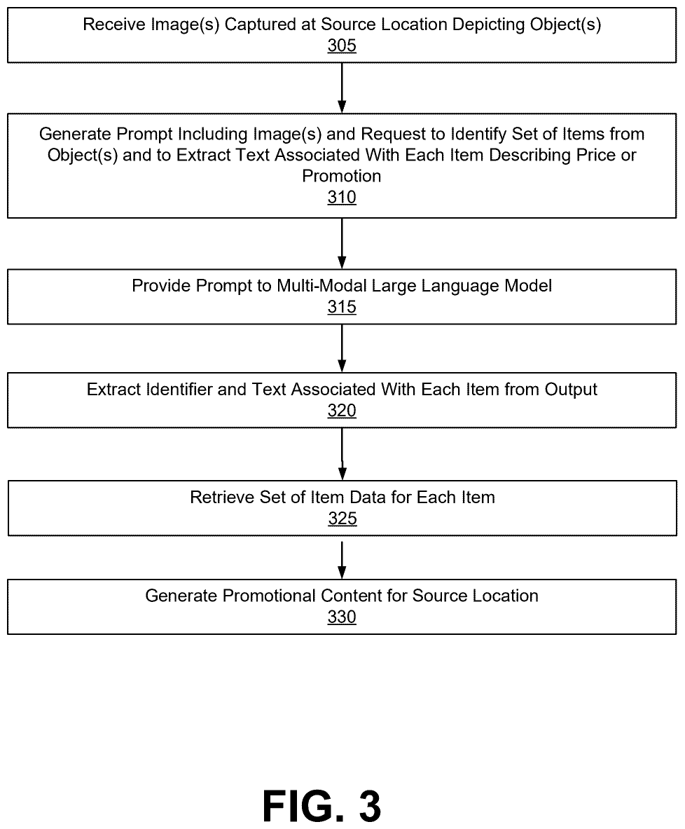

FIG. 3 is a flowchart for a method for generating promotional content based on content extracted by a large language model from an image captured at a source location, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

In some embodiments, the online system 140 determines (e.g., using the incentive module 216) whether to offer an incentive for capturing one or more images or videos depicting one or more items at a source location and a type or an amount of the incentive that should be offered. An incentive may be monetary (e.g., a bonus) or non-monetary (e.g., priority access to offers to service orders). The online system 140 may make the determination based on an amount of time that has elapsed since a time that a price of an item at the source location was last received by the online system 140 (e.g., via the data collection module 200), a number of items at the source location for which the online system 140 has not received prices for at least a threshold amount of time, or any other suitable types of information. Once the online system 140 determines that an incentive should be offered for capturing the images or videos depicting the items at the source location and a type or an amount of the incentive, the online system 140 may send (e.g., using the interface module 211) information describing the incentive to one or more picker client devices 110. Information describing the incentive for capturing the images or videos depicting the items may be sent to a picker client device 110 via a push notification, an email, or via any other suitable means. Once sent to a picker client device 110, the picker client device 110 may display the information describing the incentive.

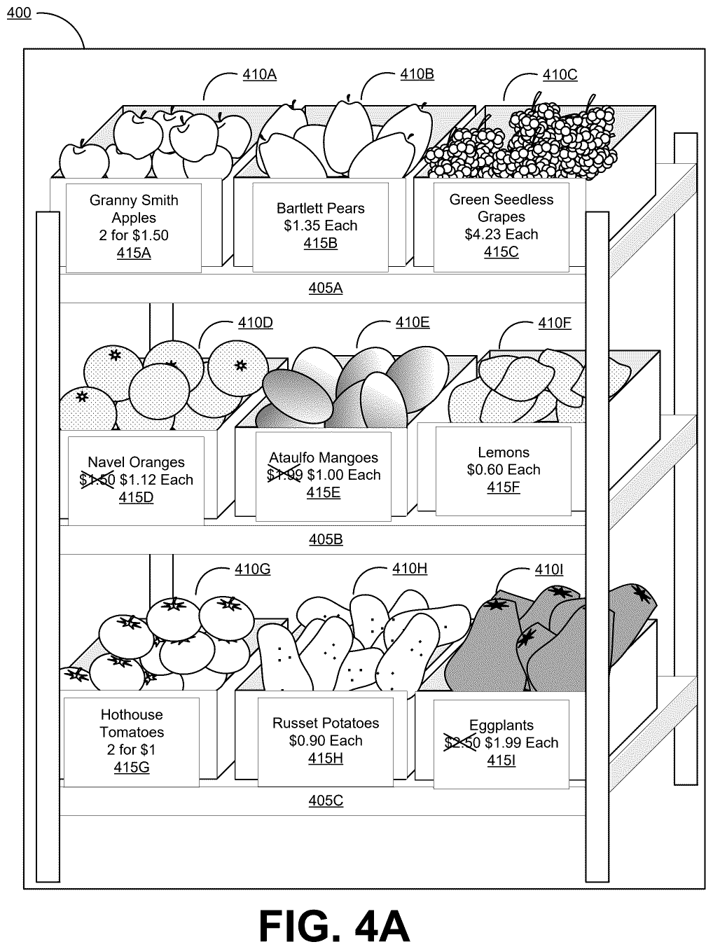

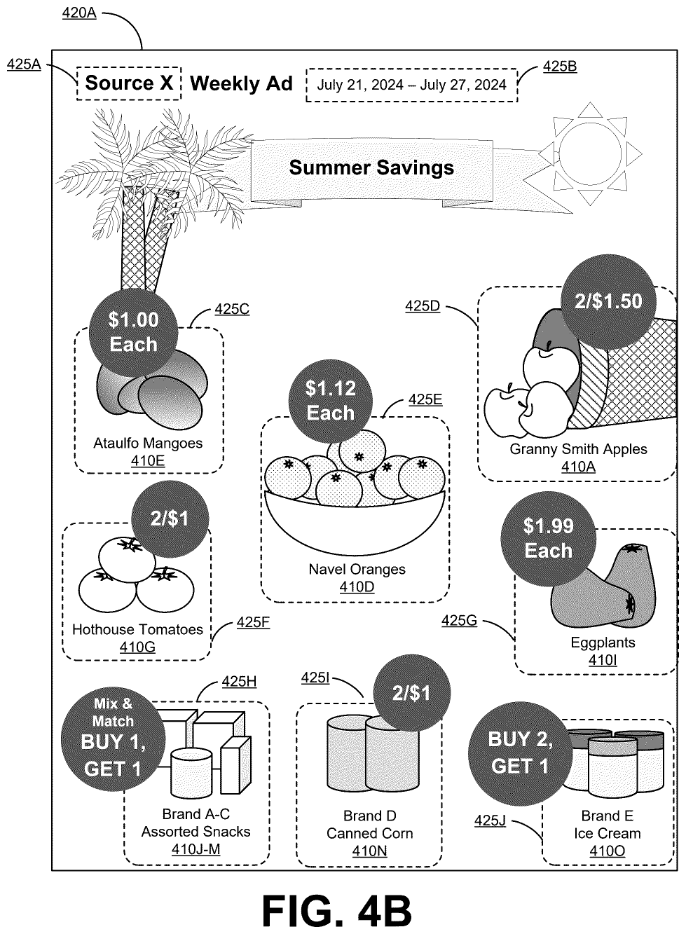

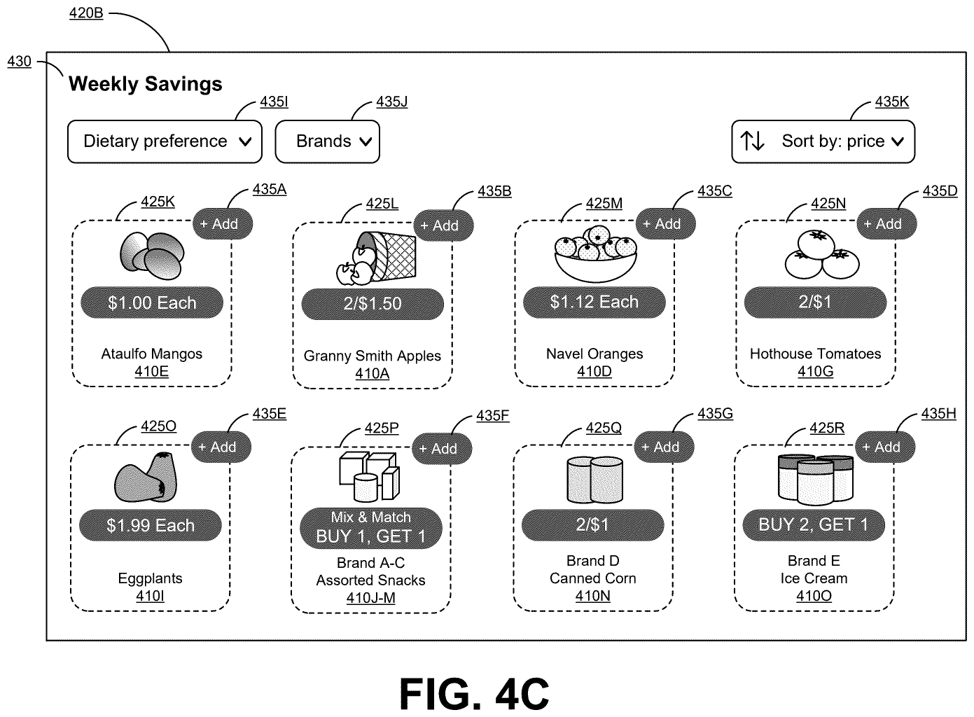

The online system 140 may then receive 305 (e.g., via the data collection module 200) one or more images or videos captured at the source location. The images or videos may depict one or more objects corresponding to items, organizational elements (e.g., aisles, shelves, display cases, etc.), labels, banners, or any other suitable types of objects. For example, as shown in FIG. 4A, which illustrates an example of an image captured at a source location, in accordance with one or more embodiments, an image 400 captured at the source location may depict shelves 405A-C at the source location, in which multiple types of items 410A-I are arranged on the shelves 405A-C. In this example, the image 400 also may depict labels 415A-I including a name of each item 410A-I, a price of each item 410A-I, and a promotion associated with each item 410A-I, if any. The online system 140 may store (e.g., using the data collection module 200) the images 400 or videos (e.g., in the data store 240) in association with information identifying the source location, a time at which each image 400 or video was captured, or any other suitable types of information. The online system 140 may receive 305 the images 400 or videos from a picker client device 110, a user client device 100, a source computing system 120, etc.

In embodiments in which the online system 140 stores the images 400 or videos it receives 305, the online system 140 subsequently may retrieve (e.g., using the extraction module 215) the images 400 or videos (e.g., from the data store 240). In some embodiments, the images 400 or videos retrieved by the online system 140 are captured within a threshold amount of time of a current time. For example, the images 400 or videos retrieved by the online system 140 may have been captured at the source location since a time that the newest promotions became available at the source location.

Referring again to FIG. 3, once the online system 140 receives 305 the images 400 or videos captured at the source location, the online system 140 may generate 310 (e.g., using the extraction module 215) a prompt. The prompt may include the images 400 or videos captured at the source location. The prompt also may include a request to identify a set of items 410 available at the source location from one or more objects depicted in the images 400 or videos based on item data for items 410 available at the source location, such as a catalog of items 410. Additionally, the prompt may include a request to extract, for each identified item 410, text associated with a corresponding item 410 from the images 400 or videos, in which the text describes a price or a promotion. Promotions associated with items 410 may include a sale (e.g., a flash sale), a coupon (e.g., $1.00 off), a discount (e.g., 30% off), an offer (e.g., buy one, get one half off), a free sample or trial, a rebate, a bundle (e.g., mix and match three items 410 of the same brand to get $2.00 off), or any other suitable types of promotions. The prompt also may include item data for items 410 available at the source location, such as a catalog of items 410. Additionally, the prompt may include information that may be used to infer that an identified item 410 is associated with a promotion (e.g., a sale banner, a price of the item 410 is crossed out and replaced with a lower price, etc.), or any other suitable types of information.

The online system 140 may then provide 315 (e.g., using the extraction module 215) the prompt to a multi-modal large language model (LLM) or any other suitable type of generative artificial intelligence (AI) model to obtain an output. The multi-modal LLM (or other generative AI model) may be fine-tuned based on item data for items 410 available at the source location (e.g., a catalog of items 410). The multi-modal LLM (or other generative AI model) also may access the item data for the items 410 via an application programming interface (API). The multi-modal LLM (or other generative AI model) may apply one or more computer vision algorithms, such as you only look once (YOLO), optical character recognition (OCR), etc., to the images 400 or videos captured at the source location included in the prompt. The computer vision algorithms may identify, from the objects depicted in the images 400 or videos, the set of items 410 available at the source location. The computer vision algorithms also may extract, for each identified item 410, the text describing a price or a promotion associated with a corresponding item 410 from the images 400 or videos. In some embodiments, text extracted by the computer vision algorithms also includes information describing or identifying an item 410, such as a stock keeping unit (SKU), a brand, an item category, etc. associated with the item 410. The multi-modal LLM (or other generative AI model) also may apply one or more natural language processing (NLP) techniques to any text it extracts.

Once the online system 140 obtains (e.g., via the extraction module 215) the output from the multi-modal LLM (or other generative AI model), the online system 140 may extract 320 (e.g., using the extraction module 215), from the output, an identifier and text associated with each item 410 included among the set of items 410 available at the source location. An identifier associated with an item 410 may correspond to a stock keeping unit (SKU), a price look-up (PLU) code, a serial number, one or more attributes (e.g., an item category or a combination of a brand, an item category, and a version or variety associated with the item 410), or any other suitable type of identifier. As described above, text associated with each item 410 may include a price or a promotion associated with a corresponding item 410. For example, as shown in FIG. 4A, the online system 140 may extract 320, from the output of the multi-modal LLM, an item category (e.g., “Granny Smith apple”) and a promotion (e.g., “2 for $1.50”) associated with a first item 410A available at the source location and an item category (e.g., “Bartlett pear”) and a price (e.g., “$1.35 Each”) associated with a second item 410B available at the source location. In this example, the online system 140 also may extract 320, from the output, an item category (e.g., “green seedless grapes”) and a price (e.g., “$4.23 Each”) associated with a third item 410C available at the source location, an item category (e.g., “navel orange”), a price (e.g., “$1.12”), and a promotion (e.g., $0.38 off an original price of $1.50) associated with a fourth item 410D available at the source location, etc. In some embodiments, once the online system 140 extracts 320 a price or a promotion associated with an item 410, the online system 140 stores (e.g., using the data collection module 200) or updates (e.g., using the data collection module 200) item data for the item 410 (e.g., in the data store 240) with the price or promotion.

Referring back to FIG. 3, the online system 140 may then retrieve 325 (e.g., using the interface module 211, from the data store 240), a set of item data for each item 410 (e.g., an image 400 and a description of the item 410) included among the set of items 410 available at the source location. The set of items 410 may be identified based on the identifier for each item 410 extracted 320 by the online system 140. In some embodiments, the online system 140 only retrieves 325 a set of item data for each item 410 available at the source location that is associated with a promotion.

In various embodiments, the online system 140 also retrieves (e.g., using the scoring module 212) various types of data (e.g., a set of user data for a user, a set of item data for an item 410, etc. from the data store 240) and predicts (e.g., using the scoring module 212) a user engagement score for an item 410 based on the retrieved information. A user engagement score is specific to a user and indicates a likelihood of an interaction by the user with an item 410 available at a source location. A user may interact with an item 410 available at a source location by adding the item 410 to an ordering list, placing an order including the item 410, etc. A user engagement score may correspond to a value, such as a number or a percentage. In some embodiments, the online system 140 predicts a user engagement score for an item 410 using an engagement prediction model, which is a machine-learning model trained to predict a user engagement score for an item 410. To use the engagement prediction model, the online system 140 may access (e.g., using the scoring module 212) the model (e.g., from the data store 240) and apply (e.g., using the scoring module 212) the model to a set of inputs. The set of inputs may include one or more types of data (e.g., user data, item data, etc.) retrieved by the online system 140 described above or any other suitable types of information. Once the online system 140 applies the engagement prediction model to the set of inputs, the online system 140 may receive (e.g., via the scoring module 212) an output from the model, which may include a value corresponding to a user engagement score for an item 410. Furthermore, once the online system 140 predicts a user engagement score for an item 410, the online system 140 may store it (e.g., in the data store 240 using the data collection module 200). In some embodiments, the engagement prediction model is trained by the online system 140 (e.g., using the machine-learning training module 230).

The online system 140 may then generate 330 (e.g., using the interface module 211) promotional content for the source location. The online system 140 may do so based on a price or a promotion associated with each item 410 included among the set of items 410 available at the source location, other types of item data for each item 410 retrieved 325 by the online system 140, source data associated with the source location, or any other suitable types of information. The promotional content for the source location may be static or interactive. For example, the promotional content for the source location may be a static flyer in a Portable Document Format (PDF). Alternatively, in the above example, the promotional content may be an interactive flyer including images 400 of items 410, in which each image 400 of an item 410 corresponds to an interactive element, such that a pop-up window with information describing an item 410 and an option to add the item 410 to an ordering list appear upon receiving an interaction with an image 400 of the item 410.

The online system 140 may generate 330 the promotional content for the source location based on a template for the promotional content. As described above, formats for promotional content for a source location may include a newsletter, an interactive collection of items 410, etc. The online system 140 may select (e.g., using the interface module 211) the template from the template data (e.g., in the data store 240) based on a set of preferences associated with a source that operates the source location. The online system 140 also may select the template based on a number of items 410 available at the source location that may be included in the promotional content, types of promotions associated with the items 410, one or more attributes of the items 410, or any other suitable types of information.

In embodiments in which the online system 140 generates 330 the promotional content for the source location based on a template for the promotional content, once the online system 140 selects the template, the online system 140 may generate 330 the promotional content. The online system 140 may do so by populating (e.g., using the interface module 211) the template with an image 400 and a description of each of the set of items 410 available at the source location and overlaying (e.g., using the interface module 211) a price or a promotion associated with each item 410 (e.g., onto a portion of the image 400 of the item 410). As described below, in some embodiments, the online system 140 ranks (e.g., using the ranking module 213) the set of items 410 available at the source location (e.g., based on a price, a promotion, a score, etc. associated with each item 410). In such embodiments, the online system 140 may populate the template with an image 400 and a description of each of the set of items 410 based on the ranking (e.g., such that a highest ranked item 410 occupies a most prominent slot of the template, a second-highest ranked item 410 occupies a second-most prominent slot of the template, etc.). Furthermore, in embodiments in which the ranking is based on information that is specific to a user (e.g., a user engagement score), the promotional content may be generated for the user.

In embodiments in which the online system 140 ranks the set of items 410 available at the source location, the online system 140 may do so based on various types of information associated with the set of items 410. In some embodiments, the online system 140 ranks the set of items 410 based on a set of item data for each item 410, such as a price or a promotion associated with each item 410 (e.g., such that a rank of an item 410 is inversely proportional to its price or proportional to an amount or a percentage of a discount associated with the item 410). In embodiments in which the online system 140 predicts user engagement scores for items 410, the online system 140 also may rank the set of items 410 based on user engagement scores associated with a user (e.g., such that a rank of an item 410 is proportional to the user engagement score for the item 410).

FIGS. 4B-4C illustrate examples of promotional content generated based on a template and content extracted by a large language model from an image 400 captured at a source location, in accordance with one or more embodiments, and continue the example described above in conjunction with FIG. 4A. Referring first to the example of FIG. 4B, suppose that a template for a weekly flyer 420A for the source location has a format corresponding to a newsletter. In this example, the template may include a background, a slot 425A that may be populated with a name of the source location, a slot 425B that may be populated with a timeframe during which the prices or promotions are valid, and slots 425C-J that may be populated with images 400 and descriptions of items 410 available at the source location. Continuing with this example, portions of the images 400 of the items 410 may be overlaid with prices or promotions associated with the corresponding items 410. Referring now to the example of FIG. 4C, suppose instead that the template for the weekly flyer 420B has a format corresponding to an interactive collection of items 410. In this example, the template may include a title 430 associated with the collection of items 410 (e.g., “Weekly Savings”) and slots 425K-R that may be populated with images 400 and descriptions of items 410 available at the source location. Continuing with this example, portions of the slots 425K-R may be overlaid with prices or promotions associated with the corresponding items 410. In the above example, the template also may include interactive elements 435A-H (e.g., a “+Add” button) associated with the items 410 that allow the items 410 to be added to an ordering list, interactive elements 435I-J that allow the items 410 to be filtered (e.g., based on one or more dietary preferences or brands), and an interactive element 435K that allows the items 410 to be sorted (e.g., by price, discount, etc.).

Once the online system 140 generates 330 the promotional content for the source location, it subsequently may execute various steps associated with the promotional content. In some embodiments, the online system 140 stores (e.g., using the data collection module 200) the promotional content (e.g., in the data store 240). The online system 140 also may receive (e.g., via the interface module 211) a request from a user client device 100 associated with a user of the online system 140 to access the promotional content for the source location and send (e.g., using the interface module 211) the promotional content to the user client device 100, causing the user client device 100 to display the promotional content. Furthermore, in some embodiments, once the online system 140 generates 330 the promotional content, it communicates information describing the promotional content to a source that operates the source location for approval (e.g., via a source computing system 120 associated with the source). In such embodiments, once the online system 140 receives (e.g., via the interface module 211) approval for the promotional content, it stores the promotional content or sends it to a user client device 100 in response to receiving a request to access the promotional content from the user client device 100.

In some embodiments, once the online system 140 updates item data (e.g., in a catalog of items 410) with a price or a promotion associated with an item 410, the online system 140 receives (e.g., via the interface module 211) a request from a user client device 100 to access a user interface, such as the ordering interface or another type of user interface, in which the user interface includes information describing the item 410. In such embodiments, the online system 140 then retrieves (e.g., using the interface module 211), from the updated item data, the price, the promotion, or other types of information associated with the item 410, and generates (e.g., using the interface module 211) the user interface based on the retrieved information. The online system 140 may then send (e.g., using the interface module 211) the user interface to the user client device 100, causing the user client device 100 to display the user interface.

In one or more embodiments, the online system 140 logs user interactions with the user interface on the user client device 100, which may communicate the user interactions back to the online system 140. This communication may be performed, in one or more embodiments, only after the user device 100 has been opted in for such feedback to be sent to the online system 140. The logged information may thereafter be used to retrain the scoring module 212, or any other model, to improve its output based on observed continuing user interactions with the online system 140. In this way, the models used by eth online system 140 improve over time and remain relevant as other systems or contextual factors change.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

1. A method, performed at a computing system comprising a processor and a computer-readable medium, comprising:
determining that stored information describing an item stocked at a source location is stale;
responsive to determining that the stored information is stale, transmitting an instruction to a picker device to capture one or more images of the item at the source location along with text displayed at the source location describing the item;
receiving, at the computing system, the one or more images captured at the source location from the picker device, the one or more images depicting one or more objects comprising the item and the text;
generating a prompt comprising:
the one or more images captured at the source location,
a request to identify, from the one or more objects depicted in the one or more images, a set of items available at the source location based at least in part on a database of items available at the source location, and
a request to extract, for each identified item, the text from the one or more images, wherein the text describes one or more of a price or a promotion;
providing the prompt to a multi-modal large language model to obtain an output, wherein the multi-modal large language model is fine-tuned based at least in part on the database of items available at the source location;
extracting, from the output of the multi-modal large language model, an identifier and the text associated with each item of the set of items available at the source location;
retrieving a set of item data for each item of the set of items based at least in part on the identifier associated with a corresponding item;
generating content for the source location based at least in part on the set of item data and the one or more of the price or the promotion associated with each item of the set of items; and
sending the content for the source location to a client device associated with a user, causing the client device to display the content.

2. The method of claim 1, wherein generating the content for the source location based at least in part on the set of item data and the one or more of the price or the promotion associated with each item of the set of items comprises:
populating a template for the content with an image and a description of each item of the set of items; and
overlaying a portion of the image of each item of the set of items with the one or more of the price or the promotion associated with a corresponding item.

3. The method of claim 2, further comprising:
selecting the template for the content based at least in part on a set of preferences associated with a source that operates the source location.

4. The method of claim 3, wherein selecting the template for the content based at least in part on the set of preferences associated with the source that operates the source location comprises:
selecting a format of the template for the content from one or more of: a newsletter or an interactive collection of items.

5. The method of claim 1, wherein generating the content for the source location based at least in part on the set of item data and the one or more of the price or the promotion associated with each item of the set of items comprises:
ranking the set of items based at least in part on the one or more of the price or the promotion associated with each item of the set of items; and
generating the content for the source location based on the ranking.

6. The method of claim 5, wherein sending the content for the source location to the client device is responsive to:
receiving, from a client device associated with a user of the computing system, a request to access the content for the source location.

7. The method of claim 6, wherein ranking the set of items based at least in part on the one or more of the price or the promotion associated with each item of the set of items comprises:
accessing a machine-learning model trained to predict a user engagement score for an item available at a source location, wherein the machine-learning model is trained by:
receiving item data for a plurality of items available at one or more source locations,
receiving user data for a plurality of users of the computing system,
receiving, for each item of the plurality of items, a label describing user engagement by one or more users with a corresponding item, and
training the machine-learning model based at least in part on the item data, the user data, and the label for each item;
applying the machine-learning model to predict the user engagement score for each item of the set of items based at least in part on a set of user data for the user, the set of item data for each item of the set of items, and the one or more of the price or the promotion associated with a corresponding item; and
ranking the set of items based at least in part on the user engagement score predicted for each item of the set of items.

8. The method of claim 1, further comprising:
updating the database of items with the one or more of the price or the promotion associated with each item of the set of items;
receiving, from a client device associated with a user of the computing system, a request to access a user interface comprising information describing an item of the set of items;
retrieving, from the updated database of items, the one or more of the price or the promotion associated with the item;
generating the user interface based at least in part on the one or more of the price or the promotion associated with the item; and
sending the user interface to the client device associated with the user, causing the client device to display the user interface.

9. The method of claim 1, wherein receiving the one or more images captured at the source location comprises:
receiving the one or more images from a client device associated with a picker.

10. The method of claim 9, further comprising:
sending, to the client device associated with the picker, information describing an incentive for the picker to capture the one or more images at the source location.

11. A computer program product comprising a non-transitory computer-readable storage medium having instructions encoded thereon that, when executed by a processor, cause the processor to perform steps comprising:
determining that stored information describing an item stocked at a source location is stale;
responsive to determining that the stored information is stale, transmitting an instruction to a picker device to capture one or more images of the item at the source location along with text displayed at the source location describing the item;
receiving, at a computing system, the one or more images captured at the source location from the picker device, the one or more images depicting one or more objects comprising the item and the text;
generating a prompt comprising:
the one or more images captured at the source location,
a request to identify, from the one or more objects depicted in the one or more images, a set of items available at the source location based at least in part on a database of items available at the source location, and
a request to extract, for each identified item, the text from the one or more images, wherein the text describes one or more of a price or a promotion;
providing the prompt to a multi-modal large language model to obtain an output, wherein the multi-modal large language model is fine-tuned based at least in part on the database of items available at the source location;
extracting, from the output of the multi-modal large language model, an identifier and the text associated with each item of the set of items available at the source location;
retrieving a set of item data for each item of the set of items based at least in part on the identifier associated with a corresponding item;
generating content for the source location based at least in part on the set of item data and the one or more of the price or the promotion associated with each item of the set of items; and
sending the content for the source location to a client device associated with a user, causing the client device to display the content.

12. The computer program product of claim 11, wherein generating the content for the source location based at least in part on the set of item data and the one or more of the price or the promotion associated with each item of the set of items comprises:
populating a template for the content with an image and a description of each item of the set of items; and
overlaying a portion of the image of each item of the set of items with the one or more of the price or the promotion associated with a corresponding item.

13. The computer program product of claim 12, wherein the computer-readable storage medium further has instructions encoded thereon that, when executed by the processor, cause the processor to perform steps comprising:
selecting the template for the content based at least in part on a set of preferences associated with a source that operates the source location.

14. The computer program product of claim 13, wherein selecting the template for the content based at least in part on the set of preferences associated with the source that operates the source location comprises:
selecting a format of the template for the content from one or more of: a newsletter or an interactive collection of items.

15. The computer program product of claim 11, wherein generating the content for the source location based at least in part on the set of item data and the one or more of the price or the promotion associated with each item of the set of items comprises:
ranking the set of items based at least in part on the one or more of the price or the promotion associated with each item of the set of items; and
generating the content for the source location based on the ranking.

16. The computer program product of claim 15, wherein sending the content for the source location to the client device is responsive to:
receiving, from a client device associated with a user of the computing system, a request to access the content for the source location.

17. The computer program product of claim 16, wherein ranking the set of items based at least in part on the one or more of the price or the promotion associated with each item of the set of items comprises:
accessing a machine-learning model trained to predict a user engagement score for an item available at a source location, wherein the machine-learning model is trained by:
receiving item data for a plurality of items available at one or more source locations,
receiving user data for a plurality of users of the computing system,
receiving, for each item of the plurality of items, a label describing user engagement by one or more users with a corresponding item, and
training the machine-learning model based at least in part on the item data, the user data, and the label for each item;
applying the machine-learning model to predict the user engagement score for each item of the set of items based at least in part on a set of user data for the user, the set of item data for each item of the set of items, and the one or more of the price or the promotion associated with a corresponding item; and
ranking the set of items based at least in part on the user engagement score predicted for each item of the set of items.

18. The computer program product of claim 11, wherein the computer-readable storage medium further has instructions encoded thereon that, when executed by the processor, cause the processor to perform steps comprising:
updating the database of items with the one or more of the price or the promotion associated with each item of the set of items;
receiving, from a client device associated with a user of the computing system, a request to access a user interface comprising information describing an item of the set of items;
retrieving, from the updated database of items, the one or more of the price or the promotion associated with the item;
generating the user interface based at least in part on the one or more of the price or the promotion associated with the item; and
sending the user interface to the client device associated with the user, causing the client device to display the user interface.

19. The computer program product of claim 11, wherein receiving the one or more images captured at the source location comprises:
receiving the one or more images from a client device associated with a picker.

20. A computing system comprising:
a processor; and
a non-transitory computer-readable storage medium storing instructions that, when executed by the processor, perform actions comprising:
determining that stored information describing an item stocked at a source location is stale;
responsive to determining that the stored information is stale, transmitting an instruction to a picker device to capture one or more images of the item at the source location along with text displayed at the source location describing the item;
receiving, at the computing system, the one or more images captured at the source location from the picker device, the one or more images depicting one or more objects comprising the item and the text;
generating a prompt comprising:
the one or more images captured at the source location,
a request to identify, from the one or more objects depicted in the one or more images, a set of items available at the source location based at least in part on a database of items available at the source location, and
a request to extract, for each identified item, the text from the one or more images, wherein the text describes one or more of a price or a promotion;
providing the prompt to a multi-modal large language model to obtain an output, wherein the multi-modal large language model is fine-tuned based at least in part on the database of items available at the source location;
extracting, from the output of the multi-modal large language model, an identifier and the text associated with each item of the set of items available at the source location;
retrieving a set of item data for each item of the set of items based at least in part on the identifier associated with a corresponding item;
generating content for the source location based at least in part on the set of item data and the one or more of the price or the promotion associated with each item of the set of items; and
sending the content for the source location to a client device associated with a user, causing the client device to display the content.
